(19) United States
(12) Patent Application Publication
(10) Pub. No.: US 2008/0282826 A1
(43) Pub. Date: Nov. 20, 2008

(54) Roller Track for a Roller Screw

(76) Inventors: Hung-Sung PAN, Taichung (TW); Wen-Chia Wu, Taichung (TW)

Correspondence Address: Dr. BANGER SHIA, 102 Lindencrest Ct., Sugar Land, TX, 77479-5201, US

(21) Appl. No.: 11/748,544

(22) Filed: May 15, 2007

(51) Int. Cl. F16C 19/02

(52) U.S. Cl. 74/439

(57) ABSTRACT

A roller track for a roller screw is formed on a screw and a nut of the roller screw respectively, and the roller track is similar to a V-shaped structure. Round angles with the same radius are formed on the outer edges for contacting rollers. Thereby, the roller chain of the present invention can avoid the two problems of the stress centralization of the rollers and the excessively small contact length of the rollers, further to lift the load capability of the roller screw.

### BACKGROUND OF THE INVENTION

1. Field of the Invention

The present invention relates to a roller screw, and more particularly to a roller track for a roller screw, which avoids the stress centralization of rollers and the excessively small contact length of the rollers, further lifts the load capability of the roller screw.

2. Description of the Prior Art

Roller screw is used more and more widely in modern industries. In addition to its high precision transmission performance, the roller screw also has many other advantages, such as low friction loss, high ratio of energy conversion, low noise, high rigidity and wear-resistance. Therefore, it is self-evident that the roller screw is very important to various industrial mechanisms.

Presently, a roller track is provided in the nut and the screw for enabling the rollers between the nut and the screw to circulate endlessly and eliminate the stress therein.

The known conventional roller tracks are shown in FIGS. 1-2, please refer to the following descriptions:

FIGS. 1-2 show a conventional roller track disclosed by U.S. Pat. No. 3,055,230, wherein, a roller screw comprises a screw 10, a nut 11 and a plurality of rollers 12, the rollers 12 are allowed to roll along a helical roller track 13 between the screw 10 and the nut 11, and the helical roller track 13 is a V-shaped groove in cross section. Any roller 12 is line-to-line contacted with the side surface of the V-shaped roller track 13 formed in the screw 10 and the nut 11, so as to enable the roller screw to bear the exterior axial thrust. The above conventional technology still has the following shortcomings:

Since the rollers 12 are line-to-line contacted with roller track 13 from the tooth bottom to the tip. A contacting portion between the V-shaped tooth and the roller 12 is a peaked point A which will cause the contact surface between the roller 12 and the helical roller track 13 to be discontinuous, and instantly cause a stress concentration. The stress concentrated at the peaked point A will cause damage to a part of the screw 10 and the nut 11, further to reduce the whole load capacity of the roller screw and the service life.

The present invention has arisen to mitigate and/or obviate the afore-described disadvantages.

### SUMMARY OF THE INVENTION

The primary objective of the present invention is to provide a roller track for a roller screw, which can avoid the stress centralization of rollers and the excessively small contact length of the rollers, further lift the load capability of the roller screw.

To obtain such an objective, the roller track for the roller screw in accordance with the present invention is formed in the screw and the nut respectively, and the roller track is similar to a symmetrical V-shaped structure in cross section, the roller track for the roller screw in accordance with the present invention is characterized in that:

A round angle is formed on an outer edge of the roller rack for contacting rollers, and the round angles are allowed to be the same round angles in radius or the different round angles in radius.

It is import that, the roller track for the roller screw in accordance with the present invention is introduced by the research efforts of experiments and the tests, and it is found that if the roller track for the roller screw is formed with round angles with the same radius, furthermore, the ratio of the radius of the round angle to the length of the roller is ranged from 0.015 to 0.115, then it will obtain a relatively high load capability and a relatively contact length.

### BRIEF DESCRIPTION OF THE DRAWINGS

FIG. 1 is a cross sectional view of an assembly disclosed by U.S. Pat. No. 3,055,230;

FIG. 2 is an enlarged view of the assembly disclosed by U.S. Pat. No. 3,055,230

FIG. 3 is a cross sectional view of a roller track for a roller screw in accordance with the present invention in an assembled state;

FIG. 4 is an enlarged cross sectional view of the roller track for the roller screw in accordance with the present invention in an assembled state;

FIG. 5 is a perspective view of the roller screw in accordance with the present invention;

FIG. 6 is a perspective view of a nut of the roller screw in accordance with the present invention;

FIG. 7 is a cross sectional view of a relatively small round angle in accordance with the present invention;

FIG. 8 is an enlarged cross sectional view of the relatively small round angle in accordance with the present invention;

FIG. 9 is a cross sectional view of a relatively large round angle in accordance with the present invention;

FIG. 10 is an enlarged cross sectional view of the relatively large round angle in accordance with the present invention;

FIG. 11 shows a roller in accordance with the present invention; and

FIG. 12 shows experiment data in accordance with the present invention.

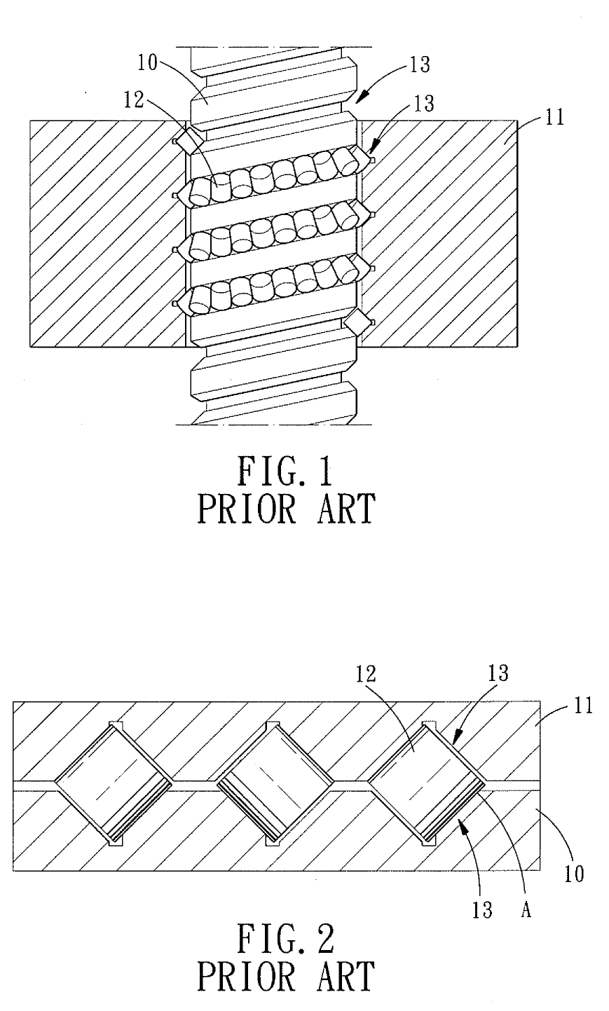

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

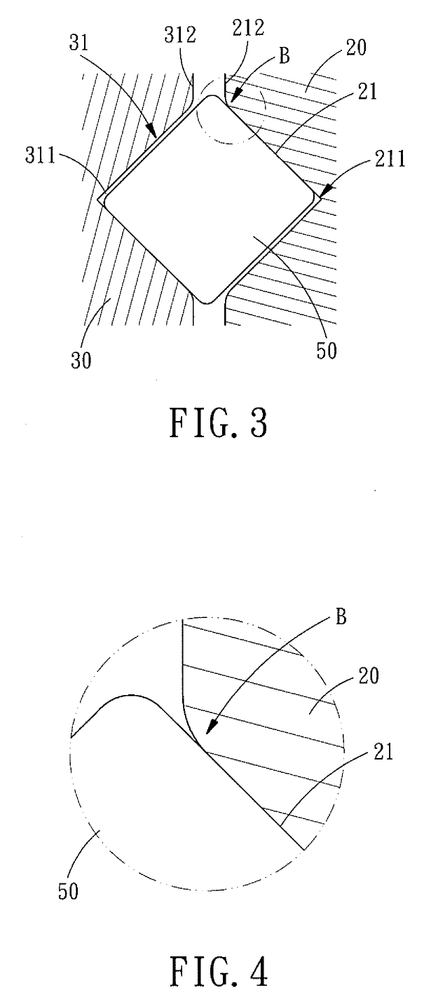

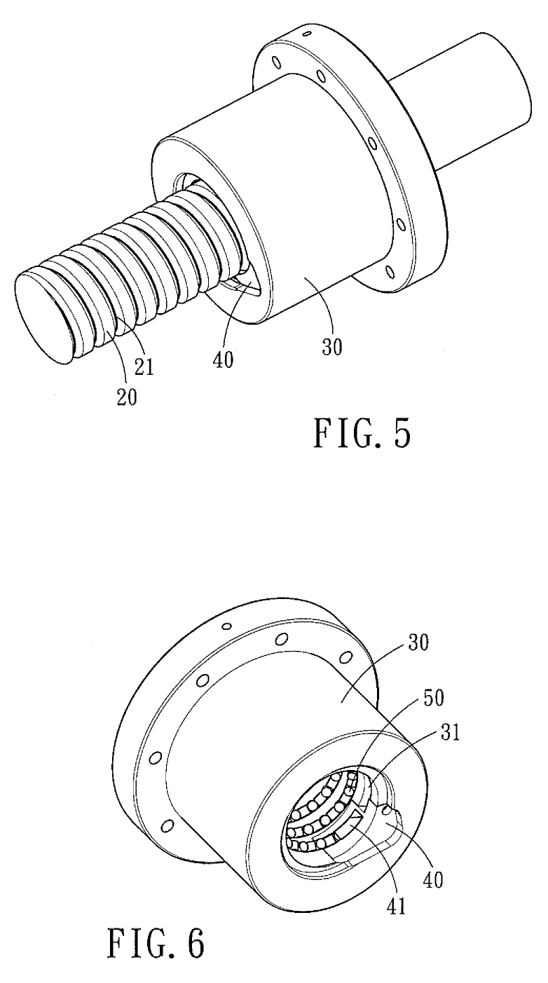

Referring to FIGS. 3-6, a roller track for a roller screw of the preferred embodiment in accordance with the present invention is characterized in that: the roller screw of the present invention comprises a screw 20, a nut 30 and a re-circulation assembly 40 and a plurality of rollers 50, wherein the nut 30 is screwed on the screw 20, the re-circulation assembly 40 is mounted in the nut 30, and the rollers 50 are arranged to move in the roller screw.

The outer surface of the screw 20 and the inner surface of the nut 30 are respectively provided with two helical roller tracks 21, 31 located correspondingly to each other. The re-circulation assembly 40 includes a re-circulation path 41 connected with the helical roller track 31 of the nut 30, moreover, the two helical roller tracks 21, 31 and the re-circulation path 41 are fitted together to form a close loading path for rollers 50 to move therein.

The roller track for the roller screw of the present invention is characterized in that the helical roller tracks 21, 31 are V-shaped in cross section; the contacting portion of the tips 212, 312 for contacting the rollers 50 is a round angle B. The proper round angles B can avoid the stress concentration caused by a relatively small acute angle and the increase of the stress value. Thereby, the present invention can avoid the stress concentration of the rollers, and can lift the load capability. The aforementioned is the summary of the positional relationship of the respective components of the preferred embodiment in accordance with the present invention.

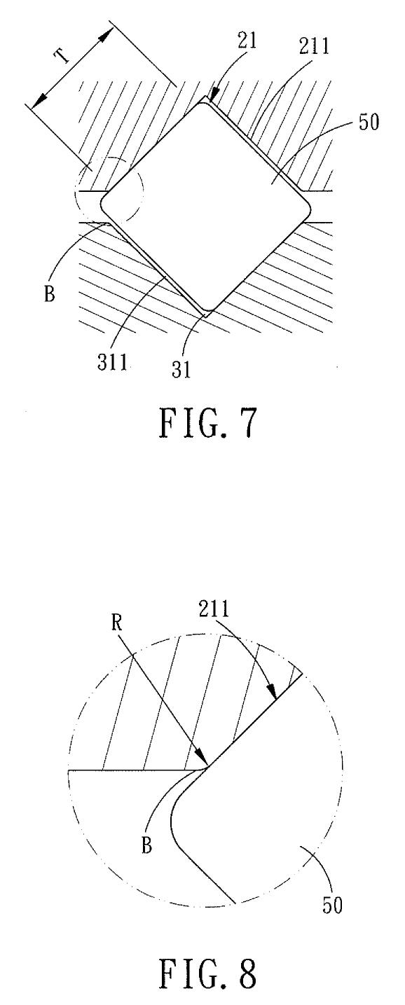

It is to be noticed that, please refer to FIGS. 7-10, the Hertz contact mechanics and the finite element method are applied in the present invention to emulate the state of the contact of the rollers and the V-shaped tooth, and the peaked contacting point of the tip of the V-shaped tooth is processed to be a proper round angle, but experiments are still required to obtain an appropriate value of the round angle.

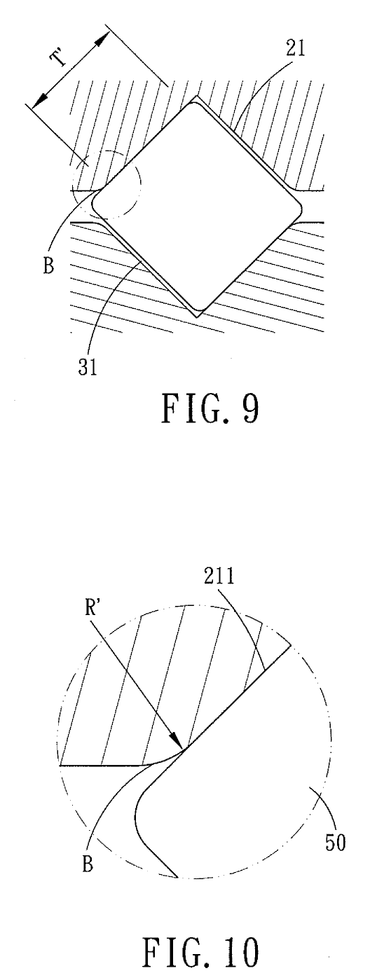

Firstly, please refer to FIGS. 7-8 of showing an excessively small round angle and FIGS. 9-10 of showing an excessively large round angle, the present invention has to avoid the stress concentration caused by the excessively small round angle and the increase of the stress value caused by the excessively large round angle. Two contact lengths with respect to the excessively small round angles and the excessively large angles are T′, T respectively. The radius R′ of a relatively large angle B can make the contact areas between the rollers 50 and the grooves 211, 311 of the V-shaped roller tracks 21, 31 change slowly, so as to avoid causing the stress centralization on a position where the contact surface starts to change. But the extensively large radius R′>R of the round angle will shorten the whole contact length T′<T of the rollers 50 and the V-shaped grooves 211, 311, so as to cause the increase of the whole contact stress.

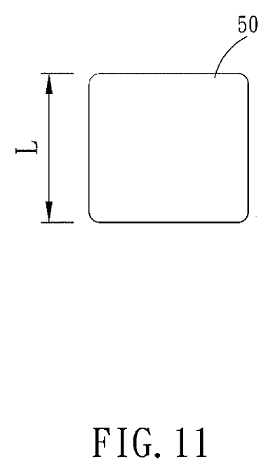

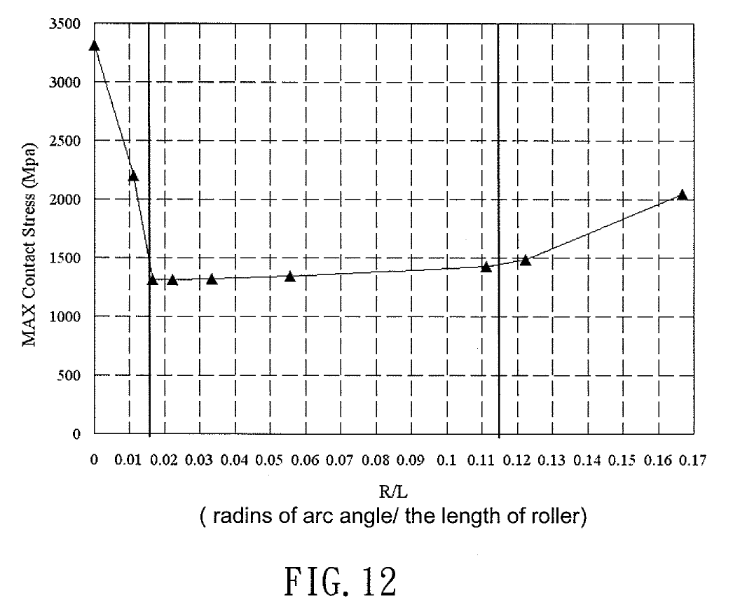

Likewise, after introducing the finite element analysis to emulate the state of the contact of the rollers 50 and the grooves 211, 311, it can be found that if the load is the same, the maximum contact stress of the V-shaped grooves 211, 311 changes with the ratio (as shown in FIG. 11) of the radius of the round angle B to the length L of the roller, and the change of the maximum contact stresses of the V-shaped grooves 211, 311 within the range 0.015≦R/L≦0.115 is much smaller than of the change when the R/L value is out of the range 0.015≦R/L≦0.115. Hence, the round angle B of the tips 212, 213 is optimally designed to satisfy the relation 0.015≦R/L≦0.115, and the experiment data are shown in the FIG. 12.

To summarize, the roller track for the roller screw of the present invention is characterized in the screw and the nut, and the roller track is V-shaped in cross section, the round angles are formed on the outer edges of the roller rack for contacting rollers, in such a manner, it can avoid the two problems of the stress centralization of the rollers and the excessively small contact length of the rollers, and further lift the load capability of the roller screw.

While we have shown and described various embodiments in accordance with the present invention, it is clear to those skilled in the art that further embodiments may be made without departing from the scope of the present invention.

What is claimed is:

1. A roller track for a roller screw being formed in a screw and a nut of the roller screw respectively, and the roller track being a symmetrical V-shaped structure in cross section, an improvement of the roller track is that: arc angles are formed on outer edges of the roller rack for contacting rollers.

2. The roller track for a roller screw as claimed in claim 1, wherein the arc angles are the same round angles in radius.

3. The roller track for a roller screw as claimed in claim 2, wherein a ratio of the radius of the round angles to a length of the roller is ranged from 0.015 to 0.115.

4. The roller track for a roller screw as claimed in claim 1, wherein the arc angles are different in radius.
